(19) United States
(12) Patent Application Publication
(10) Pub. No.: US 2025/0187676 A1
(43) Pub. Date: Jun. 12, 2025

(54) JOINT STRUCTURE OF VEHICLE BODY

(71) Applicants: Hyundai Motor Company, Seoul (KR); Kia Corporation, Seoul (KR)

(72) Inventors: Jeehwan Choi, Hwaseong-si (KR); Chulhee Heo, Hwaseong-si (KR); SunKi Choi, Hwaseong-si (KR)

(21) Appl. No.: 18/896,185

(22) Filed: Sep. 25, 2024

(30) Foreign Application Priority Data
Dec. 8, 2023 (KR) 10-2023-0177671

(51) Int. Cl. B62D 27/06; B60R 13/02; B60R 13/06; B62D 25/06; B62D 63/02

(52) U.S. Cl. CPC B62D 27/065; B60R 13/0212; B60R 13/06; B62D 25/06; B62D 63/025

(57) ABSTRACT

An embodiment joint structure of a vehicle body includes a front body module fixed to a front portion of an under body, a rear body module detachably mounted at a rear portion of the under body and a rear portion of the front body module, a flange apparatus extending in an inward direction of the vehicle body from the rear portion of the front body module and a front portion of the rear body module, and a sealing member connected to the flange apparatus.

### CROSS-REFERENCE TO RELATED APPLICATIONS

This application claims the benefit of Korean Patent Application No. 10-2023-0177671, filed on Dec. 8, 2023, which application is hereby incorporated herein by reference.

### TECHNICAL FIELD

The present invention relates to a vehicle body.

### BACKGROUND

Recently, the vehicle industry is introducing a new concept of future mobility vision for realizing a human-centered, dynamic future city. One of these future mobility solutions is a purpose built vehicle (PBV) as a purpose-based mobility.

A PBV can be an example of an electric vehicle (EV)-based environment-friendly mobile vehicle. This PBV can provide various customized services to users while moving from the starting point to the destination in an unmanned autonomous driving method.

The vehicle body of such a PBV includes an under body (also referred to as a rolling chassis or a skateboard in the art) and an upper body assembled to the under body.

Here, the upper body may be configured in various forms according to the type of customized service of the PBV. For example, the PBV can be used as a hailing type vehicle having cabins respectively configured in the front and rear parts of the upper body. Furthermore, the PBV may be used as a cab type vehicle in which a cabin is configured only in the front portion of the upper body. Furthermore, the PBV may be used as a delivery type vehicle in which a cabin is configured in the front portion of the upper body and a luggage room is configured in the rear part.

The PBV can only be used as a hailing or delivery vehicle, but if users can change its purpose, the vehicle's usage time can increase significantly.

In other words, if the vehicle's purpose can be easily changed, the front cabin of the vehicle, including the driver's seat of the upper body, and the under body are made of a common configuration, and if the rear of the upper body is configured to be easily replaceable, the vehicle usability can be increased while reducing costs.

Matters described in this background section are prepared to enhance understanding of the background of embodiments of the invention and may include matters other than the already known prior art.

### SUMMARY

The present invention relates to a vehicle body. Particular embodiments relate to a joint structure that can be applied to the production of various body types.

Embodiments of the present disclosure provide a joint structure of a vehicle body that can be easily changed into various types of vehicle bodies to increase the usability of the PBV.

A joint structure of a vehicle body according to an embodiment may include a front body module as a fixed part fixed to a front portion of an under body, a rear body module as a detachable variable part mounted at a rear portion of the under body and a rear portion of the front body module, a flange unit extending in an inward direction of the vehicle body from the rear portion of the front body module and a front portion of the rear body module, and a sealing member connected to the flange unit.

The flange unit may include a roof flange formed on each of a fixed part roof structure of the front body module and a variable part roof structure of the rear body module, a side flange formed on each of a fixed part side structure of the front body module and a variable part side structure of the rear body module, and a floor flange formed on each of a fixed part floor structure of the front body module and a variable part floor structure of the rear body module.

The fixed part roof structure and the variable part roof structure may be connected along the front-to-back direction of the vehicle body through roof fastening members.

The fixed part side structure and the variable part side structure may be connected along the front-to-back direction of the vehicle body through side fastening members.

The fixed part floor structure and the variable part floor structure may be connected along the front-to-back direction of the vehicle body through floor fastening members.

The sealing member may include a double sealing weather strip connected to the roof flange, the side flange, and the floor flange on the inside of the vehicle body, and it may be formed with a plurality of sealing ribs.

The roof flange may be formed on a fixed part roof rail assembly of the fixed part roof structure and on a variable part roof rail assembly of the variable part roof structure.

The side flange may be formed on a fixed part pillar inner member assembly of the fixed part side structure and on a variable part pillar inner member assembly of the variable part side structure.

The floor flange portion may be formed on a fixed part cross member assembly of the fixed part floor structure and on a variable part cross member assembly of the variable part floor structure.

The joint structure may further include a roof molding member mounted between a fixed part roof panel connected to the fixed part roof rail assembly and a variable part roof panel connected to the variable part roof rail assembly.

The joint structure may further include a side molding member mounted between a fixed part side outer panel connected to the fixed part pillar inner member assembly and a variable part side outer panel connected to the variable part pillar inner member assembly.

The joint structure may further include a floor molding member mounted between a fixed part floor panel connected to the fixed part cross member assembly and a variable part floor panel connected to the variable part cross member assembly.

The joint structure may further include a fixed part joint unit connecting both sides of the fixed part roof structure and an upper part of the fixed part side structure and connecting a lower part of the fixed part side structure and both sides of the fixed part floor structure, and a variable part joint unit connecting both sides of the variable part roof structure and an upper part of the variable part side structure and connecting a lower part of the variable part side structure and both sides of the variable part floor structure.

The fixed part joint unit may include a first fixed part joint bracket connected to both sides of a fixed part roof rail assembly of the fixed part roof structure and the upper part of a fixed part pillar inner member assembly of the fixed part side structure and a second fixed part joint bracket connected to a lower part of a fixed part pillar inner member assembly of the fixed part side structure and both sides of a fixed part cross member assembly of the fixed part floor structure.

The variable part joint unit may include a first variable part joint bracket connected to both sides of a variable part roof rail assembly of the variable part roof structure and an upper part of the variable part pillar inner member assembly of the variable part side structure, and a second variable part joint bracket connected to a lower part of the variable part pillar inner member assembly of the variable part side structure and both sides of a variable part cross member assembly of the variable part floor structure.

The first fixed part joint bracket and the first variable part joint bracket may be connected along the front-to-back direction of the vehicle body through a first joint fastening member.

The second fixed part joint bracket and the second variable part joint bracket may be connected along the front-to-back direction of the vehicle body through a second joint fastening member.

According to the joint structure of a vehicle body according to embodiments of the present invention, the PBV can be easily changed into various types of vehicle bodies to increase the usability of the PBV and reduce the manufacturing cost of the PBV.

In addition, effects that can be obtained or expected due to embodiments of the present invention will be disclosed directly or implicitly in the detailed description of the embodiments of the present invention. That is, various effects expected according to embodiments of the present invention will be disclosed in the detailed description to be described later.

### BRIEF DESCRIPTION OF THE DRAWINGS

Since these drawings are for reference in explaining exemplary embodiments of the present invention, the technical ideas of the embodiments of the present invention should not be construed as being limited to the accompanying drawings.

FIG. 1 is a block diagram showing a joint structure of a vehicle body according to an embodiment.

FIG. 2 is a perspective view showing the joint structure of a vehicle body according to an embodiment.

FIG. 3 and FIG. 4 are partially exploded perspective views showing the joint structure of a vehicle body according to an embodiment.

FIG. 5 is a cross-sectional view along line A-A of FIG. 2.

FIG. 6 is a cross-sectional view along line B-B of FIG. 2.

FIG. 7 is a cross-sectional view along line C-C of FIG. 2.

FIG. 8 is a perspective view showing a fixed part joint unit applied to the joint structure of a vehicle body according to an embodiment.

FIG. 9 is a perspective view illustrating a variable part joint unit applied to the joint structure of a vehicle body according to an embodiment.

FIG. 10 and FIG. 11 are drawings showing an engage structure of the fixed part joint unit and the variable part joint unit applied to the joint structure of a vehicle body according to an embodiment.

The following reference identifiers may be used in connection with the figures to describe various features of embodiments of the present invention.

| | |
|---|---|
| 1: under body | 3: upper body |
| 10: front body module | 10a: fixed part |
| 11: fixed part side structure | 13: fixed part side outer panel |
| 15: fixed part pillar inner member | |
| assembly | |
| 17: first fixed part pillar inner member | 17a: fifth junction flange |
| 19: second fixed part pillar inner | 19a: sixth junction flange |
| member | |
| 21: fixed part roof structure | 23: fixed part roof panel |
| 25: fixed part roof rail assembly | 27: first fixed part roof rail |
| 27a: first junction flange | 29: second fixed part roof rail |
| 29a: second junction flange | 31: fixed part floor structure |
| 33: fixed part floor panel | |
| 35: fixed part cross member assembly | 37: first fixed part cross member |
| 37a: ninth junction flange | 39: second fixed part cross |
| | member |
| 39a: tenth junction flange | 40: rear body module |
| 40a: variable part | 41: variable part side structure |
| 43: variable part side outer panel | |
| 45: variable part pillar inner member | |
| assembly | |
| 47: first variable part pillar inner | 47a: seventh junction flange |
| member | |
| 49: second variable part pillar inner | 49a: eighth junction flange |
| member | |
| 51: variable part roof structure | 53: variable part roof panel |
| 55: variable part roof rail assembly | 57: first variable part roof rail |
| 57a: third junction flange | 59: second variable part roof rail |
| 59a: fourth junction flange | 61: variable part floor structure |
| 63: variable part floor panel | |
| 65: variable part cross member | 67: first variable part cross |
| assembly | member |
| 67a: eleventh junction flange | |
| 69: second variable part cross member | 69a: twelfth junction flange |
| 71: roof fastening member | 72: side fastening member |
| 73: floor fastening member | 100: joint structure of a vehicle |
| | body |
| 100a: vehicle body | 110: flange unit |
| 111: fixed part roof flange | 121: variable part roof flange |
| 131: roof molding member | 141: fixed part side flange |
| 151: variable part side flange | 161: side molding member |
| 171: fixed part floor flange | 181: variable part floor flange |
| 191: floor molding member | 210: sealing member |
| 211: sealing rib | 215: double sealing weather strip |
| 410: fixed part joint unit | 411: first fixed part joint bracket |
| 413: second fixed part joint bracket | 510: variable part joint unit |
| 511: first variable part joint bracket | |
| 513: second variable part joint bracket | 611: first joint fastening member |
| 612: second joint fastening member | |

The drawings referenced above are not necessarily drawn to scale, but they should be understood as presenting a somewhat simplified representation of various preferred features illustrating the basic principles of embodiments of the present invention. The specific design features of embodiments of the invention, including, for example, specific dimensions, orientations, locations, and shapes, will be determined in part by the particular intended application and usage environment.

### DETAILED DESCRIPTION OF ILLUSTRATIVE EMBODIMENTS

Hereinafter, with reference to the attached drawings, exemplary embodiments of the present invention will be described in detail so that those skilled in the art can easily implement embodiments of the present invention. As those skilled in the art would realize, the described embodiments may be modified in various different ways, all without departing from the spirit or scope of the present invention.

The terminology used herein is for the purpose of describing specific embodiments only and is not intended to limit the embodiments. As used herein, singular forms are intended to also include plural forms, unless the context clearly indicates otherwise.

In addition, in the detailed description below, the names of the components are divided into first, second, etc. to distinguish them when the components are in a similar relationship, and the description below is not necessarily limited to that order.

As used herein, the terms ‘comprise’ and/or ‘comprising’ indicate the presence of specified features, integers, steps, operations, elements, and/or components, but may also include one or more other features, integers, or steps. It should also be understood that this does not exclude the presence or addition of elements, operations, components, and/or groups thereof.

As used herein, the term ‘and/or’ includes any one or all combinations of one or more items listed in association.

In this specification, the term ‘connected’ indicates a physical relationship between two components in which the components are directly connected to each other by welding, rivets, self piercing rivet (SPR), flow drill screw (FDS), structural adhesive, etc., or indirectly connected through one or more intermediate components.

As used herein, ‘vehicle,’ ‘vehicular,’ ‘automotive,’ or other similar terms as used herein generally refer to passenger vehicles, sports cars, sport utility vehicles (SUVs), buses, trucks, and various commercial vehicles including passenger automobiles, hybrid vehicles, electric vehicles, hybrid electric vehicles, electric vehicle-based PBVs, hydrogen-powered vehicles, and other alternative fuel vehicles (e.g., other than petroleum fuel derived from resources).

Hereinafter, embodiments of the present invention will be described in detail with reference to the accompanying drawings.

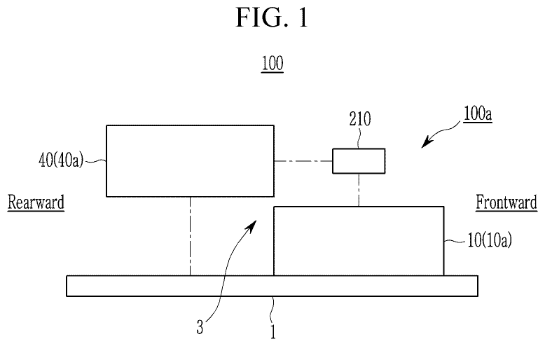

FIG. 1 is a block diagram showing a joint structure of a vehicle body according to an embodiment.

Referring to FIG. 1, a joint structure 100 according to an embodiment may be applied to, for example, a vehicle body 100a of a purpose-based mobility vehicle (purpose built vehicle: hereinafter referred to as ‘PBV’).

The PBV can be utilized as an electric car-based life module vehicle that provides various customized services to users during the time it takes to move from the departure point to the destination.

As an example, the PBV can be manufactured as a 1 box type design with a wide interior space. Furthermore, the PBV may have facing-type seats applied to the interior space.

The vehicle body of this PBV is suitable for small-quantity production of various vehicle types with a small number of parts, and it can be manufactured in various shapes and sizes.

Furthermore, the vehicle body 100a of the PBV includes a skateboard type under body 1, (which is also commonly referred to as a ‘rolling chassis’ or ‘chassis frame’ by those skilled in the art) and an upper body 3 assembled to the under body 1.

The under body 1 can accommodate components such as a battery assembly and a drive motor. And, the upper body 3 is a body in white (BIW) body that is connected to the under body 1 and may include a cabin and luggage room with a wide interior space.

In this specification, the ‘front-to-back direction of the vehicle body’ may be defined as the longitudinal direction of the vehicle body, the ‘vehicle width direction’ may be defined as the left-right direction of the vehicle body, and the ‘up-and-down direction’ may be defined as the height direction of the vehicle body.

Furthermore, in this specification, ‘upper end,’ ‘upper portion,’ or ‘upper surface’ of a component indicates an end, portion, or surface of a component that is relatively upper in the drawing, and ‘lower end,’ ‘lower portion,’ or ‘lower surface’ of a component indicates an end, portion, or surface of a component that is relatively lower in the drawing.

Furthermore, in this specification, an end of a component (e.g., one end or another (other) end, etc.) denotes an end of a component in any one direction, and an end portion of the component (e.g., one end portion) or other (another) end portion, etc.) denotes a portion of a component that includes that end.

The joint structure 100 of a vehicle body 100a according to an embodiment is a structure that may apply the upper body 3 of various shapes and purposes to the under body 1 according to the type of customized service of the PBV.

The joint structure 100 according to an embodiment includes the upper body 3 assembled to the under body 1, the upper body 3 including a front body module 10 and a rear body module 40.

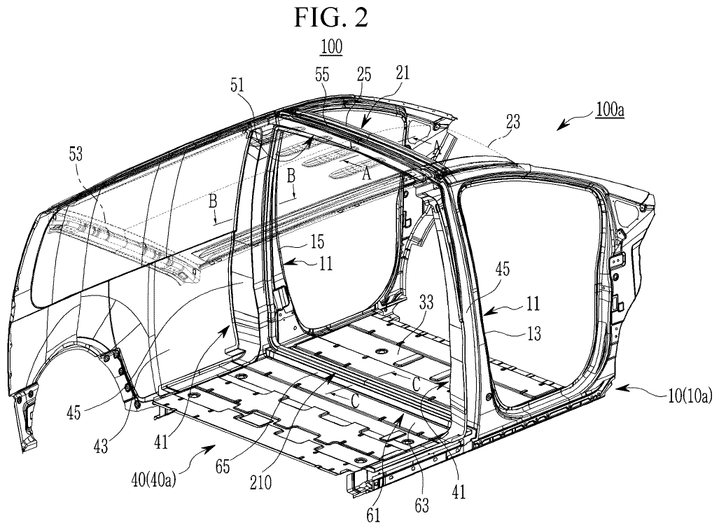

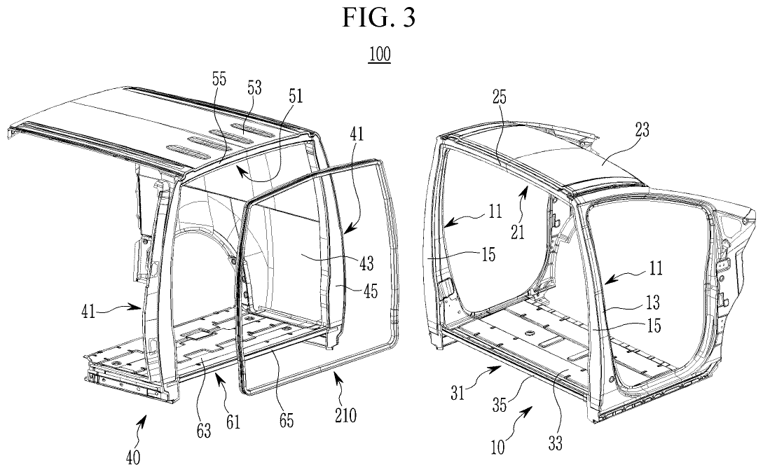

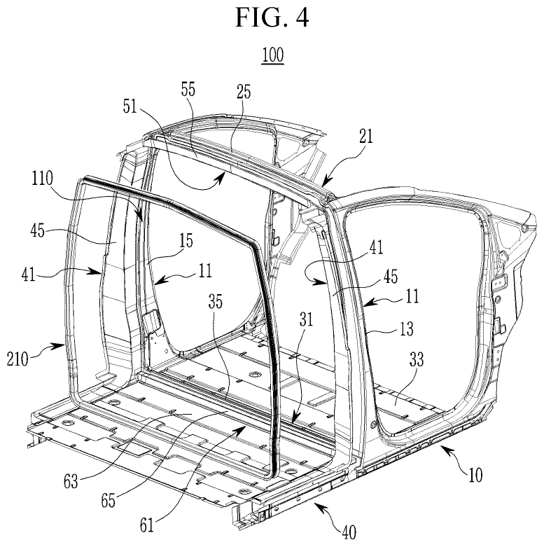

FIG. 2 is a perspective view showing the joint structure of a vehicle body according to an embodiment, and FIG. 3 and FIG. 4 are partially exploded perspective views showing the joint structure of a vehicle body according to an embodiment.

Referring to FIG. 1 to FIG. 4, in an embodiment, the front body module 10 includes a front cabin of a cab type. The front body module 10 may be fixed to the front portion of the under body 1.

The front body module 10 may be attached to the front portion of the under body 1 along the vertical direction via a vehicle body mounting unit known to a person of ordinary skill in the art. The front body module 10 may be a fixed part 10a fixed to the front portion of the under body 1. The fixed part 10a is a component that is joined to the under body 1 and is a component that is not replaced even if the intended use of the vehicle changes.

The front body module 10 includes a fixed part side structure 11, a fixed part roof structure 21, and a fixed part floor structure 31.

The fixed part side structure 11 is provided on each side of the front body module 10. The fixed part roof structure 21 connects upper parts of the fixed part side structures 11 along the vehicle width direction. The fixed part floor structure 31 connects lower parts of the fixed part side structures 11 along the vehicle width direction.

The fixed part side structure 11 includes a fixed part side outer panel 13 and a fixed part pillar inner member assembly 15 that are connected to each other. The fixed part roof structure 21 includes a fixed part roof panel 23 and a fixed part roof rail assembly 25 that are connected to each other. The fixed part floor structure 31 includes a fixed part floor panel 33 and a fixed part cross member assembly 35 that are connected to each other.

In an embodiment, the rear body module 40 includes a rear cabin or luggage room. The rear body module 40 may be connected to the rear part of the under body 1.

The rear body module 40 may be connected to the rear part of the under body 1 via a vehicle body mounting unit known to a person of ordinary skill in the art. The rear body module 40 is a component that can be replaced (or detached) depending on the vehicle's intended use and is a variable part (replaceable portion) 40a.

The rear body module 40 includes variable part side structures 41, a variable part roof structure 51, and a variable part floor structure 61.

The variable part side structure 41 is provided on each side of the rear body module 40. The variable part roof structure 51 connects upper parts of the variable part side structures 41 along the vehicle width direction. The variable part floor structure 61 connects lower portions of the variable part side structures 41 along the vehicle width direction.

The variable part side structure 41 includes a variable part side outer panel 43 and a variable part pillar inner member assembly 45 that are connected to each other. The variable part roof structure 51 includes a variable part roof panel 53 and a variable part roof rail assembly 55 that are connected to each other. The variable part floor structure 61 includes a variable part floor panel 63 and a variable part cross member assembly 65 that are connected to each other.

Meanwhile, the joint structure 100 according to an embodiment provides a structure that can be commonly applied to various types of vehicles. Here, various vehicle types mean various configurations of variable part 40a and may include, for example, a hailing vehicle as a means of transporting occupants, a delivery vehicle for transporting goods, and special vehicles such as ambulances.

Referring to FIG. 2 to FIG. 4, the joint structure 100 includes a flange unit 110 and a sealing member 210.

The flange unit 110 extends in an inward direction of the vehicle body 100a from the rear portion of the front body module 10 and the front portion of the rear body module 40.

The flange unit 110 may be formed on the fixed part side structure 11 and the variable part side structure 41 which are connectable to each other, on the fixed part roof structure 21 and the variable part roof structure 51 which are connectable to each other, and on the fixed part floor structure 31 and the variable part floor structure 61 which are connectable to each other.

In an embodiment, the sealing member 210 is configured to seal between the rear portion of the front body module 10 and the front portion of the rear body module 40.

The sealing member 210 may be connected to the flange unit 110 on the inside of the vehicle body 100a. The sealing member 210 may be formed from a flexible rubber material.

The configuration and joining structure of the flange unit 110 and the sealing member 210 according to an embodiment are described in detail below.

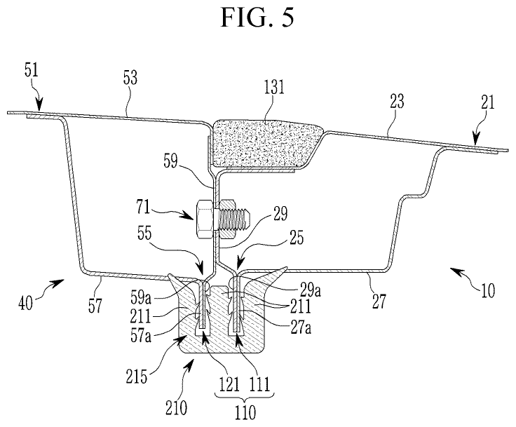

FIG. 5 is a cross-sectional view along line A-A of FIG. 2.

Referring to FIG. 5, the flange unit 110 according to an embodiment includes roof flanges 111 and 121.

The roof flanges 111 and 121 are formed on the fixed part roof structure 21 of the front body module 10 and the variable part roof structure 51 of the rear body module 40, respectively.

Hereinafter, the roof flange 111 formed on the fixed part roof structure 21 of the front body module 10 is referred to as, for better comprehension, ‘fixed part roof flange 111.’ And, for better comprehension, the roof flange 121 formed on the variable part roof structure 51 of the rear body module 40 is called ‘variable part roof flange 121.’

The fixed part roof flange 111 is formed at the fixed part roof rail assembly 25 of the fixed part roof structure 21.

The fixed part roof rail assembly 25 is connected to the fixed part roof panel 23. The fixed part roof rail assembly 25 includes a first fixed part roof rail 27 and a second fixed part roof rail 29 connected to each other.

The first fixed part roof rail 27 includes a first junction flange 27a, and the second fixed part roof rail 29 includes a second junction flange 29a.

The first junction flange 27a and the second junction flange 29a are joined to each other to form the fixed part roof flange 111.

Additionally, the variable part roof flange 121 is formed on the variable part roof rail assembly 55 of the variable part roof structure 51.

The variable part roof rail assembly 55 is connected to the variable part roof panel 53. The variable part roof rail assembly 55 includes a first variable part roof rail 57 and a second variable part roof rail 59 connected to each other.

The first variable part roof rail 57 includes a third junction flange 57a, and the second variable part roof rail 59 includes a fourth junction flange 59a.

The third junction flange 57a and the fourth junction flange 59a are joined to each other to form the variable part roof flange 121.

The fixed part roof structure 21 and the variable part roof structure 51 may be connected along the front-to-back direction of the vehicle body via a roof fastening member 71. The roof fastening member 71 may include a combination of a bolt and a nut.

A roof molding member 131 is mounted between the fixed part roof panel 23 and the variable part roof panel 53. The roof molding member 131 is configured to seal between the fixed part roof structure 21 and the variable part roof structure 51.

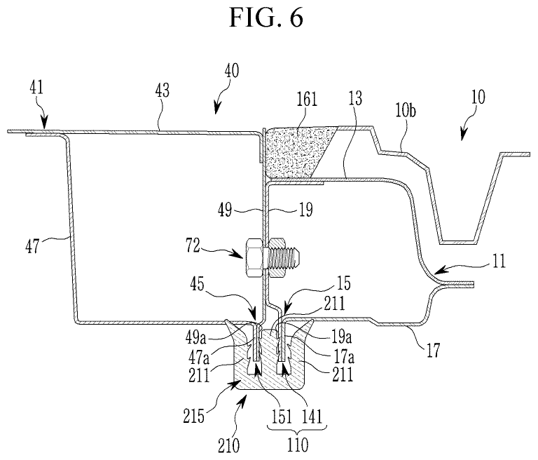

FIG. 6 is a cross-sectional view along line B-B of FIG. 2.

Referring to FIG. 6, the flange unit 110 according to an embodiment includes side flanges 141 and 151.

The side flanges 141 and 151 are formed on the fixed part side structure 11 of the front body module 10 and the variable part side structure 41 of the rear body module 40, respectively.

Hereinafter, the side flange 141 formed on the fixed part side structure 11 of the front body module 10 is referred to as, for better comprehension, ‘fixed part side flange 141.’ And, for better comprehension, the side flange 151 formed on the variable part side structure 41 of the rear body module 40 is called ‘variable part side flange 151.’

The fixed part side flange 141 is formed on the fixed part pillar inner member assembly 15 of the fixed part side structure 11.

The fixed part pillar inner member assembly 15 is connected to the fixed part side outer panel 13. The fixed part pillar inner member assembly 15 includes a first fixed part pillar inner member 17 and a second fixed part pillar inner member 19 connected to each other.

The first fixed part pillar inner member 17 includes a fifth junction flange 17a, and the second fixed part pillar inner member 19 includes a sixth junction flange 19a.

The fifth junction flange 17a and the sixth junction flange 19a are joined to each other to form the fixed part side flange 141.

And, the variable part side flange 151 is formed on the variable part pillar inner member assembly 45 of the variable part side structure 41.

The variable part pillar inner member assembly 45 is connected to the variable part side outer panel 43. The variable part pillar inner member assembly 45 includes a first variable part pillar inner member 47 and a second variable part pillar inner member 49 connected to each other.

The first variable part pillar inner member 47 includes a seventh junction flange 47a, and the second variable part pillar inner member 49 includes an eighth junction flange 49a.

The seventh junction flange 47a and the eighth junction flange 49a are joined to each other to form the variable part side flange 151.

The fixed part side structure 11 and the variable part side structure 41 may be connected along the front-to-back direction of the vehicle body via a side fastening member 72. The side fastening member 72 may include a combination of a bolt and a nut.

A side molding member 161 is mounted between the fixed part side outer panel 13 and the variable part side outer panel 43. The side molding member 161 is configured to seal between the fixed part side structure 11 and the variable part side structure 41.

Drawing reference numeral 10b, which is not described, indicates a front door assembly.

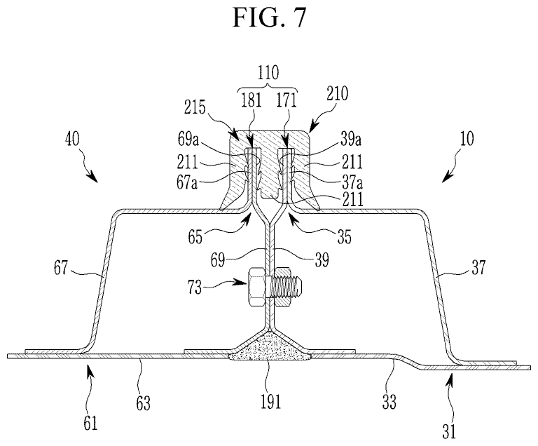

FIG. 7 is a cross-sectional view along line C-C of FIG. 2.

Referring to FIG. 7, the flange unit 110 according to an embodiment includes floor flanges 171 and 181.

The floor flanges 171 and 181 are formed on the fixed part floor structure 31 of the front body module 10 and the variable part floor structure 61 of the rear body module 40, respectively.

Hereinafter, the floor flange 171 formed on the fixed part floor structure 31 of the front body module 10 is referred to as, for better comprehension, ‘fixed part floor flange 171.’ And, for better comprehension, the floor flange 181 formed on the variable part floor structure 61 of the rear body module 40 is called ‘variable part floor flange 181.’

The fixed part floor flange 171 is formed on the fixed part cross member assembly 35 of the fixed part floor structure 31.

The fixed part cross member assembly 35 is connected to the fixed part floor panel 33. The fixed part cross member assembly 35 includes a first fixed part cross member 37 and a second fixed part cross member 39 connected to each other.

The first fixed part cross member 37 includes a ninth junction flange 37a, and the second fixed part cross member 39 includes a tenth junction flange 39a.

The ninth junction flange 37a and the tenth junction flange 39a are joined to each other and may form the fixed part floor flange 171.

The variable part floor flange 181 is formed on the variable part cross member assembly 65 of the variable part floor structure 61.

The variable part cross member assembly 65 is connected to the variable part floor panel 63. The variable part cross member assembly 65 includes a first variable part cross member 67 and a second variable part cross member 69 which are connected to each other.

The first variable part cross member 67 includes an eleventh junction flange 67a, and the second variable part cross member 69 includes a twelfth junction flange 69a.

The eleventh junction flange 67a and the twelfth junction flange 69a are joined to each other to form the variable part floor flange 181.

The fixed part floor structure 31 and the variable part floor structure 61 may be connected in the front-to-back direction of the vehicle body through a floor fastening member 73. The floor fastening member 73 may include a combination of a bolt and a nut.

A floor molding member 191 is mounted between the fixed part floor panel 33 and the variable part floor panel 63. The floor molding member 191 is configured to seal between the fixed part floor structure 31 and the variable part floor structure 61.

Referring to FIG. 4 to FIG. 7, the sealing member 210 according to an embodiment is mounted on the roof flanges 111 and 121, the side flanges 141 and 151, and the floor flanges 171 and 181 of the flange unit 110.

That is, the sealing member 210 may be mounted on the roof flanges 111 and 121, the side flanges 141 and 151, and the floor flanges 171 and 181, which are provided with double flanges.

The sealing member 210 is connected to the roof flanges 111 and 121, the side flanges 141 and 151, and the floor flanges 171 and 181 on the inner side of the vehicle body 100a. For example, the sealing member 210 may completely wrap around the inside of the vehicle body 100a along the roof flanges 111 and 121, the side flanges 141 and 151, and the floor flanges 171 and 181. Additionally, for example, the sealing member 210 may be mounted as a single piece to the roof flanges 111 and 121, the side flanges 141 and 151, and the floor flanges 171 and 181.

The sealing members 210 includes a double sealing weather strip 215 which may be connected to the roof flanges 111 and 121, the side flanges 141 and 151, and the floor flanges 171 and 181.

The double sealing weather strip 215 is configured to exhaust water inflowing from the outside to the inside of the vehicle body 100a to the lower part of the vehicle body 100a.

The double sealing weather strip 215 includes a plurality of sealing ribs 211 that may be secured to the roof flanges 111 and 121, the side flanges 141 and 151, and the floor flanges 171 and 181, which are provided with double flanges.

The sealing ribs 211 may, in one example, be provided with three ribs. The roof flanges 111 and 121, the side flanges 141 and 151, and the floor flanges 171 and 181 may be connected between the sealing ribs 211.

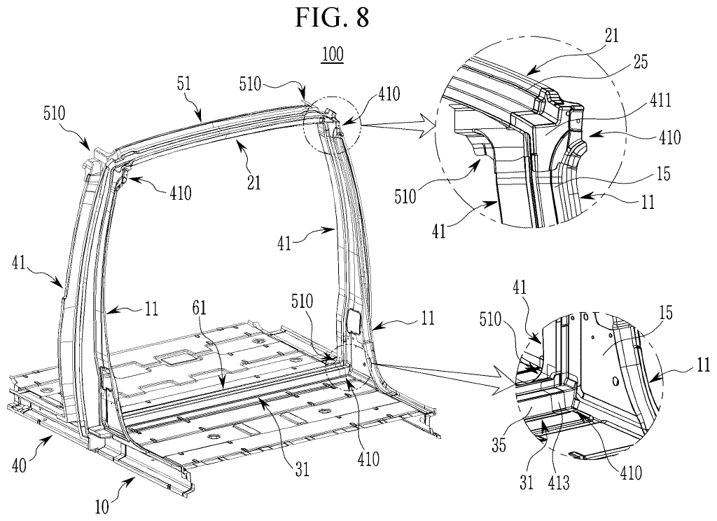

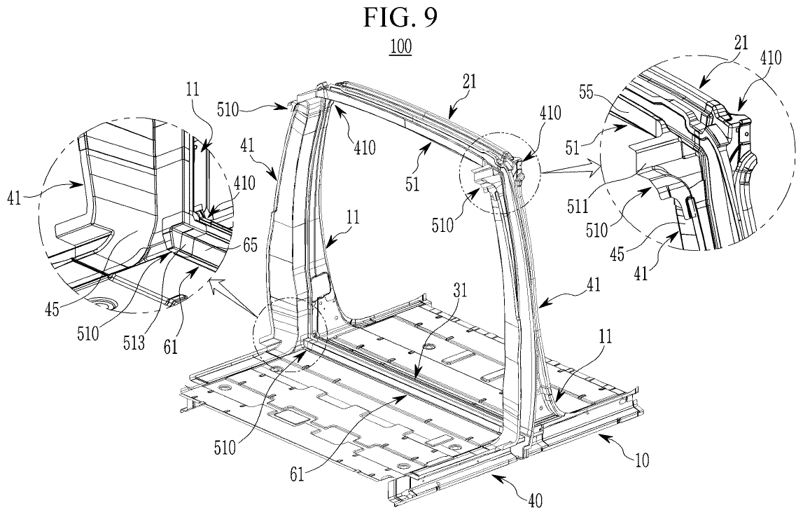

FIG. 8 is a perspective view showing a fixed part joint unit applied to the joint structure of a vehicle body according to an embodiment, and FIG. 9 is a perspective view illustrating a variable part joint unit applied to the joint structure of a vehicle body according to an embodiment.

Referring to FIG. 8 and FIG. 9, the joint structure 100 of a vehicle body may further include a fixed part joint unit 410 and a variable part joint unit 510 configured to engage the rear portion of the front body module 10 and the front portion of the rear body module 40.

The fixed part joint unit 410 connects both sides of the fixed part roof structure 21 and the upper part of the fixed part side structure 11 and connects the lower part of the fixed part side structure 11 and both sides of the fixed part floor structure 31.

As shown in FIG. 8, the fixed part joint unit 410 includes a first fixed part joint bracket 411 and a second fixed part joint bracket 413.

The first fixed part joint bracket 411 is connected to both sides of the fixed part roof rail assembly 25 of the fixed part roof structure 21 and the upper part of the fixed part pillar inner member assembly 15 of the fixed part side structure 11 by welding (e.g., two-point or three-point welding).

The second fixed part joint bracket 413 is connected to the lower part of the fixed part pillar inner member assembly 15 of the fixed part side structure 11 and to both sides of the fixed part cross member assembly 35 of the fixed part floor structure 31 by welding (e.g., two-point or three-point welding).

The variable part joint unit 510 connects both sides of the variable part roof structure 51 and the upper part of the variable part side structure 41 and connects the lower part of the variable part side structure 41 and both sides of the variable part floor structure 61.

As shown in FIG. 9, the variable part joint unit 510 includes a first variable part joint bracket 511 and a second variable part joint bracket 513.

The first variable part joint bracket 511 is connected to both sides of the variable part roof rail assembly 55 of the variable part roof structure 51 and the upper part of the variable part pillar inner member assembly 45 of the variable part side structure 41 by welding (e.g., two-point or three-point welding).

The second variable part joint bracket 513 is connected to the lower portion of the variable part pillar inner member assembly 45 of the variable part side structure 41 and to both sides of the variable part cross member assembly 65 of the variable part floor structure 61 by welding (e.g., two-point or three-point welding).

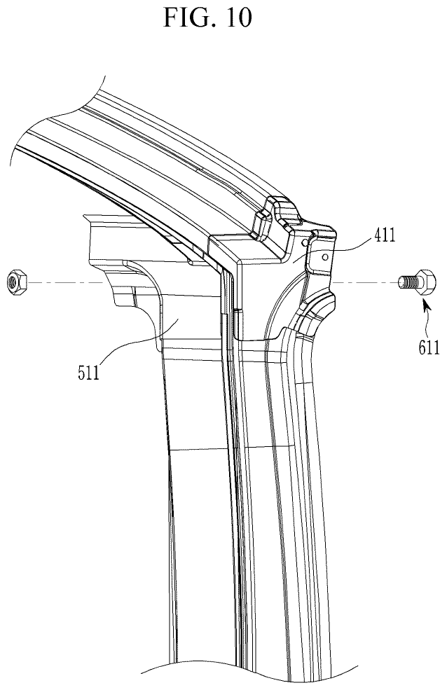

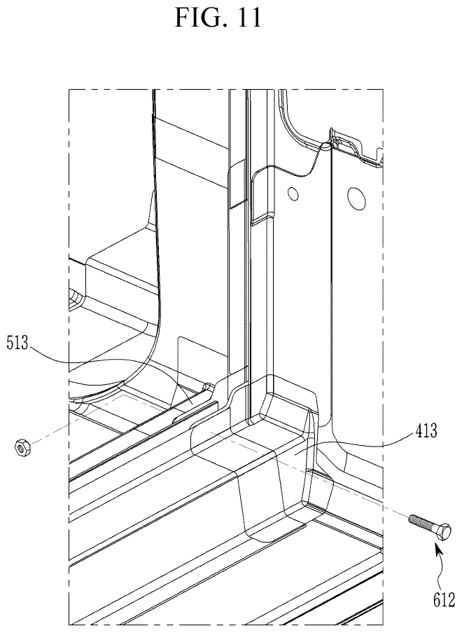

FIG. 10 and FIG. 11 are drawings showing an engage structure of the fixed part joint unit and the variable part joint unit applied to the joint structure of a vehicle body according to an embodiment.

As shown in FIG. 10, the first fixed part joint bracket 411 and the first variable part joint bracket 511 are connected along the front-to-back direction of the vehicle body via a first joint fastening member 611. The first joint fastening member 611 may include a combination of a bolt and a nut.

As shown in FIG. 11, the second fixed part joint bracket 413 and the second variable part joint bracket 513 are connected along the front-to-back direction of the vehicle body via a second joint fastening member 612. The second joint fastening member 612 may include a combination of a bolt and a nut.

Referring to FIG. 1 to FIG. 11, the assembly process and operation of the joint structure 100 according to an embodiment configured as above are described in detail.

In an embodiment, the under body 1 of a vehicle body 100a is provided.

As the upper body 3 to be assembled to the under body 1, the front body module 10 and the rear body module 40 are provided.

The front body module 10 includes the fixed part side structure 11, the fixed part roof structure 21, and the fixed part floor structure 31. The rear body module 40 includes the variable part side structure 41, the variable part roof structure 51, and the variable part floor structure 61.

The fixed part roof flange 111 is formed on the fixed part roof rail assembly 25 of the fixed part roof structure 21. The variable part roof flange 121 is formed on the variable part roof rail assembly 55 of the variable part roof structure 51. The fixed part side flange 141 is formed on the fixed part pillar inner member assembly 15 of the fixed part side structure 11. A variable part side flange 151 is formed on the variable part pillar inner member assembly 45 of the variable part side structure 41. The fixed part floor flange 171 is formed on the fixed part cross member assembly 35 of the fixed part floor structure 31. And, the variable part floor flange 181 is formed on the variable part cross member assembly 65 of the variable part floor structure 61.

The first fixed part joint bracket 411 is attached to both sides of the fixed part roof rail assembly 25 and the upper part of the fixed part pillar inner member assembly 15. The second fixed part joint bracket 413 is connected to the lower part of the fixed part pillar inner member assembly 15 and both sides of the fixed part cross member assembly 35. The first variable part joint bracket 511 is attached to both sides of the variable part roof rail assembly 55 and the upper part of the variable part pillar inner member assembly 45. And, the second variable part joint bracket 513 is joined to the lower part of the variable part pillar inner member assembly 45 and both sides of the variable part cross member assembly 65.

In this state, the front body module 10 is connected to the front portion of the under body 1 along the vertical direction. The front body module 10 may be equipped with the fixed part 10a that is fixed to the front portion of the under body 1 by the vehicle body mounting unit.

Next, the rear body module 40, which has various shapes depending on the intended use, is disposed on the rear part of the under body 1.

Then, the fixed part roof structure 21 and the variable part roof structure 51 are connected along the front-to-back direction of the vehicle body through the roof fastening member 71. The fixed part side structure 11 and the variable part side structure 41 are connected along the front-to-back direction of the vehicle body through the side fastening member 72. And, the fixed part floor structure 31 and the variable part floor structure 61 are connected in the front-to-back direction of the vehicle body through the floor fastening member 73.

Additionally, the first fixed part joint bracket 411 and the first variable part joint bracket 511 are connected along the front-to-back direction of the vehicle body via the first joint fastening member 611. And, the second fixed part joint bracket 413 and the second variable part joint bracket 513 are connected along the front-to-back direction of the vehicle body through the second joint fastening member 612.

Accordingly, the rear part of the front body module 10 and the front part of the rear body module 40 are connected along the front-to-back direction of the vehicle body on the under body 1 through the process described above.

The fixed part roof flange 111 and the variable part roof flange 121 are disposed in a direction facing each other (e.g., vehicle body front-rear direction) on the inner side of the vehicle body 100a. The fixed part side flange 141 and the variable part side flange 151 are disposed in a direction facing each other (e.g., vehicle body front-rear direction) on the inner side of the vehicle body 100a. And, the fixed part floor flange 171 and the variable part floor flange 181 are disposed in a direction facing each other on the inner side of the vehicle body 100a (e.g., the vehicle body front-rear direction).

In this condition, one-piece type double sealing weather strip 215 is provided as the sealing member 210. The double sealing weather strip 215 includes the sealing ribs 211.

The double sealing weather strip 215 is connected to the fixed part roof flange 111 and the variable part roof flange 121, the fixed part side flange 141 and the variable part side flange 151, and the fixed part floor flange 171 and the variable part floor flange 181.

The double sealing weather strip 215 may be connected to the roof flanges 111 and 121, the side flanges 141 and 151, and the floor flanges 171 and 181 by the sealing ribs 211.

The roof molding member 131 is mounted between the fixed part roof panel 23 and the variable part roof panel 53. The side molding member 161 is mounted between the fixed part side outer panel 13 and the variable part side outer panel 43. Additionally, the floor molding member 191 is mounted between the fixed part floor panel 33 and the variable part floor panel 63.

The rear body module 40 is connected along the vertical direction to the rear part of the under body 1. The rear body module 40 is connected in a vertical direction to the rear of the under body 1 by the vehicle body mounting unit. Accordingly, the rear body module 40 may be equipped as the variable part 40a connected to the rear part of the front body module 10.

According to an embodiment of the joint structure 100 as described so far, the front body module 10 as the fixed part 10a connected to the front portion of the under body 1 may be left as is, and the rear body module 40 as the variable part 40a may be connected to the rear part of the under body 1 and the front body module 10.

Therefore, the joint structure 100 according to an embodiment may replace the rear body module 40 of a predetermined shape according to the type of customized service (e.g., use case) of the PBV.

Accordingly, the joint structure 100 according to an embodiment may easily change the structure of the upper body 3 of the vehicle body depending on the purpose of use of the PBV, and the manufacturing cost of the PBV can be reduced.

Furthermore, according to an embodiment of the joint structure 100, the single piece of the double sealing weather strip 215 is connected to the flange unit 110 extending inwardly of the vehicle body 100a at the rear end of the front body module 10 and the front end of the rear body module 40.

Therefore, the joint structure 100 according to an embodiment can secure the sealing performance, water tightness performance, and sealing robustness of the front body module 10 and the rear body module 40 connected to each other.

Furthermore, according to an embodiment of the joint structure 100, the fixed part side structure 11, the fixed part roof structure 21, and the fixed part floor structure 31 of the front body module 10 are connected by the first fixed part joint bracket 411 and the second fixed part joint bracket 413.

And, according to an embodiment of the joint structure 100, the variable part side structure 41, the variable part roof structure 51, and the variable part floor structure 61 of the rear body module 40 are connected by the first variable part joint bracket 511 and the second variable part joint bracket 513.

Accordingly, the joint structure 100 according to an embodiment can secure the joint strength and connection robustness of the front body module 10 and the rear body module 40.

While embodiments of this invention have been described in connection with what is presently considered to be practical exemplary embodiments, it is to be understood that the embodiments of the invention are not limited to the disclosed embodiments. On the contrary, they are intended to cover various modifications and equivalent arrangements included within the spirit and scope of the appended claims.

What is claimed is:

1. A joint structure of a vehicle body, the joint structure comprising:
a front body module fixed to a front portion of an under body;
a rear body module detachably mounted at a rear portion of the under body and a rear portion of the front body module;
a flange apparatus extending in an inward direction of the vehicle body from the rear portion of the front body module and a front portion of the rear body module; and
a sealing member connected to the flange apparatus.

2. The joint structure of claim 1, wherein the flange apparatus comprises:
a roof flange disposed on each of a fixed part roof structure of the front body module and a variable part roof structure of the rear body module;
a side flange disposed on each of a fixed part side structure of the front body module and a variable part side structure of the rear body module; and
a floor flange disposed on each of a fixed part floor structure of the front body module and a variable part floor structure of the rear body module.

3. The joint structure of claim 2, wherein:
the fixed part roof structure and the variable part roof structure are connected along a front-to-back direction of the vehicle body through roof fastening members;
the fixed part side structure and the variable part side structure are connected along the front-to-back direction of the vehicle body through side fastening members; and
the fixed part floor structure and the variable part floor structure are connected along the front-to-back direction of the vehicle body through floor fastening members.

4. The joint structure of claim 2, wherein the sealing member comprises a double sealing weather strip connected to the roof flange, the side flange, and the floor flange inside of the vehicle body, the double sealing weather strip comprising a plurality of sealing ribs.

5. The joint structure of claim 2, wherein the roof flange is disposed on a fixed part roof rail assembly of the fixed part roof structure and on a variable part roof rail assembly of the variable part roof structure.

6. The joint structure of claim 5, further comprising a roof molding member mounted between a fixed part roof panel connected to the fixed part roof rail assembly and a variable part roof panel connected to the variable part roof rail assembly.

7. The joint structure of claim 2, wherein the side flange is disposed on a fixed part pillar inner member assembly of the fixed part side structure and on a variable part pillar inner member assembly of the variable part side structure.

8. The joint structure of claim 7, further comprising a side molding member mounted between a fixed part side outer panel connected to the fixed part pillar inner member assembly and a variable part side outer panel connected to the variable part pillar inner member assembly.

9. The joint structure of claim 2, wherein the floor flange is disposed on a fixed part cross member assembly of the fixed part floor structure and on a variable part cross member assembly of the variable part floor structure.

10. The joint structure of claim 9, further comprising a floor molding member mounted between a fixed part floor panel connected to the fixed part cross member assembly and a variable part floor panel connected to the variable part cross member assembly.

11. A joint structure of a vehicle body, the joint structure comprising:
a front body module fixed to a front portion of an under body;
a rear body module detachably mounted at a rear portion of the under body and a rear portion of the front body module;
a flange apparatus extending in an inward direction of the vehicle body from the rear portion of the front body module and a front portion of the rear body module, wherein the flange apparatus comprises:
a roof flange disposed on each of a fixed part roof structure of the front body module and a variable part roof structure of the rear body module;
a side flange disposed on each of a fixed part side structure of the front body module and a variable part side structure of the rear body module; and
a floor flange disposed on each of a fixed part floor structure of the front body module and a variable part floor structure of the rear body module;
a sealing member connected to the flange apparatus;
a fixed part joint connecting both sides of the fixed part roof structure and an upper part of the fixed part side structure and connecting a lower part of the fixed part side structure and both sides of the fixed part floor structure; and
a variable part joint connecting both sides of the variable part roof structure and an upper part of the variable part side structure and connecting a lower part of the variable part side structure and both sides of the variable part floor structure.

12. The joint structure of claim 11, wherein the fixed part joint comprises:
a first fixed part joint bracket connected to both sides of a fixed part roof rail assembly of the fixed part roof structure and an upper part of a fixed part pillar inner member assembly of the fixed part side structure; and
a second fixed part joint bracket connected to a lower part of the fixed part pillar inner member assembly of the fixed part side structure and both sides of a fixed part cross member assembly of the fixed part floor structure.

13. The joint structure of claim 12, wherein the variable part joint comprises:
a first variable part joint bracket connected to both sides of a variable part roof rail assembly of the variable part roof structure and an upper part of a variable part pillar inner member assembly of the variable part side structure; and
a second variable part joint bracket connected to a lower part of the variable part pillar inner member assembly of the variable part side structure and both sides of a variable part cross member assembly of the variable part floor structure.

14. The joint structure of claim 13, wherein the first fixed part joint bracket and the first variable part joint bracket are connected along a front-to-back direction of the vehicle body through a first joint fastening member.

15. The joint structure of claim 13, wherein the second fixed part joint bracket and the second variable part joint bracket are connected along a front-to-back direction of the vehicle body through a second joint fastening member.

16. A vehicle comprising:
a vehicle body comprising an under body, a front body module fixed to a front portion of the under body, and a rear body module detachably mounted at a rear portion of the under body and a rear portion of the front body module;
a flange apparatus extending in an inward direction of the vehicle body from the rear portion of the front body module and a front portion of the rear body module, wherein the flange apparatus comprises:
a roof flange disposed on each of a fixed part roof structure of the front body module and a variable part roof structure of the rear body module;
a side flange disposed on each of a fixed part side structure of the front body module and a variable part side structure of the rear body module; and
a floor flange disposed on each of a fixed part floor structure of the front body module and a variable part floor structure of the rear body module; and
a double sealing weather strip connected to the roof flange, the side flange, and the floor flange inside of the vehicle body, the double sealing weather strip comprising a plurality of sealing ribs.

17. The vehicle of claim 16, wherein:
the fixed part roof structure and the variable part roof structure are connected along a front-to-back direction of the vehicle body through roof fastening members;
the fixed part side structure and the variable part side structure are connected along the front-to-back direction of the vehicle body through side fastening members; and
the fixed part floor structure and the variable part floor structure are connected along the front-to-back direction of the vehicle body through floor fastening members.

18. The vehicle claim 16, wherein:
the roof flange is disposed on a fixed part roof rail assembly of the fixed part roof structure and on a variable part roof rail assembly of the variable part roof structure;
the side flange is disposed on a fixed part pillar inner member assembly of the fixed part side structure and on a variable part pillar inner member assembly of the variable part side structure; and
the floor flange is disposed on a fixed part cross member assembly of the fixed part floor structure and on a variable part cross member assembly of the variable part floor structure.

19. The vehicle of claim 18, further comprising:
a roof molding member mounted between a fixed part roof panel connected to the fixed part roof rail assembly and a variable part roof panel connected to the variable part roof rail assembly;
a side molding member mounted between a fixed part side outer panel connected to the fixed part pillar inner member assembly and a variable part side outer panel connected to the variable part pillar inner member assembly; and
a floor molding member mounted between a fixed part floor panel connected to the fixed part cross member assembly and a variable part floor panel connected to the variable part cross member assembly.

20. The vehicle of claim 16, further comprising:
a fixed part joint connecting both sides of the fixed part roof structure and an upper part of the fixed part side structure and connecting a lower part of the fixed part side structure and both sides of the fixed part floor structure; and
a variable part joint connecting both sides of the variable part roof structure and an upper part of the variable part side structure and connecting a lower part of the variable part side structure and both sides of the variable part floor structure.
